(19) United States
(12) Patent Application Publication
(10) Pub. No.: US 2003/0167597 A1
(43) Pub. Date: Sep. 11, 2003

(54) Chair caster with an immovable function

(76) Inventor: Po-Chuan Tsai, Tainan Hsien (TW)

Correspondence Address: Po-Chuan TSAI, P.O. Box 90, Tainan City, 704, TW

(21) Appl. No.: 10/091,518

(22) Filed: Mar. 7, 2002

(51) Int. Cl. B60B 33/00

(52) U.S. Cl. 16/35 R

(57) ABSTRACT

A chair caster with an immovable function in the invention mainly includes a wheel holder, a spring, a sleeve, a spindle, and a non-slip pad. When a user sits on a chair, the spindle is capable of being lowered by the weight of a user with an annular flange of the spindle pressed against the sleeve to lower the sleeve to compress the spring with both ends of the spring respectively pressed against a bottom of the sleeve and a stop end of the wheel holder so that the non-slip pad engaged at a lower portion of the spindle follows downward movement of the spindle to be affixed to the ground, thereby enabling the chair to remain immovable in a certain location without worry of displacing the chair to make the user suffered a fall and thus wounded.

### BACKGROUND OF THE INVENTION

1. Field of the Invention

This invention relates to a chair caster with an immovable function, particularly to one having a spindle capable of being lowered by the weight of a user when the user sits on a chair with an annular flange of the spindle pressed against a sleeve to lower the sleeve to compress a spring with both ends of the spring respectively pressed against a bottom of the sleeve and a stop end of a wheel holder so that a non-slip pad engaged at a lower portion of the spindle follows downward movement of the spindle to be affixed to the ground, thereby enabling the chair to remain immovable in a certain location without worry of displacing the chair to make the user suffered a fall and thus wounded.

2. Description of the Prior Art

Generally speaking, a known conventional chair caster 1, as shown in FIG. 1, has a wheel holder 10 whose upper portion is extended through by a threaded spindle 11 capable of being fixedly screwed to the wheel holder 10 by a nut 12 and whose lower portion is pivoted with a wheel body 14 by a pivot 13. However, the known chair caster 1 can roll at any time without limitation because it is not equipped with any devices to provide an immovable function. To this disadvantage, the known chair caster 1 is improved to have a braking device. However, such a braking device is very troublesome and inconvenient in use because it is provided with a braking arm or the like requiring a user to operate with one hand or one foot to control the improved chair caster 1 in an unlocked position to permit the wheel body 14 to roll or in a locked position to prevent the wheel body 14 from rolling, and is hard to achieve a complete stop because the kind of braking device only can restrict rolling movement of the wheel body 14 to make the wheel body 14 remain in a certain location without the ability to limit the swiveling of the spindle 11, i.e., the wheel body 14 is still able to be freely swiveled around in the location.

### SUMMARY OF THE INVENTION

The main purpose of the invention is to offer a chair caster capable of remaining immovable in a certain location without worry of displacing a chair to make the user suffered a fall and thus wounded.

The main feature of the invention is to provide a chair caster with an immovable function mainly including:

a wheel holder having a spindle housing disposed at an upper portion thereof and two wheel bodies pivoted at a lower portion thereof, the spindle housing provided with a spindle hole formed in a center thereof, the spindle hole provided with a stop end disposed therein;

a spring capable of being placed in the spindle hole of the wheel holder;

a sleeve capable of being placed in the spindle hole of the wheel holder and having a through hole disposed in a center thereof;

a spindle capable of extending from an upper end of the spindle hole of the wheel holder, passing through the through hole of the sleeve and the spring, and protruding out of a lower end of the spindle hole of the wheel holder, the spindle having two ring grooves respectively disposed at an upper portion and a lower portion thereof, and an annular flange disposed proximate the upper portion; and,

a non-slip pad capable of being engaged with the ring groove at the lower portion of the spindle and having a recess disposed at a center thereof, the recess provided with a circumferential ridge disposed therein.

### BRIEF DESCRIPTION OF DRAWINGS

This invention will be better understood by referring to the accompanying drawings, wherein:

FIG. 1 is a perspective view of a known conventional chair caster;

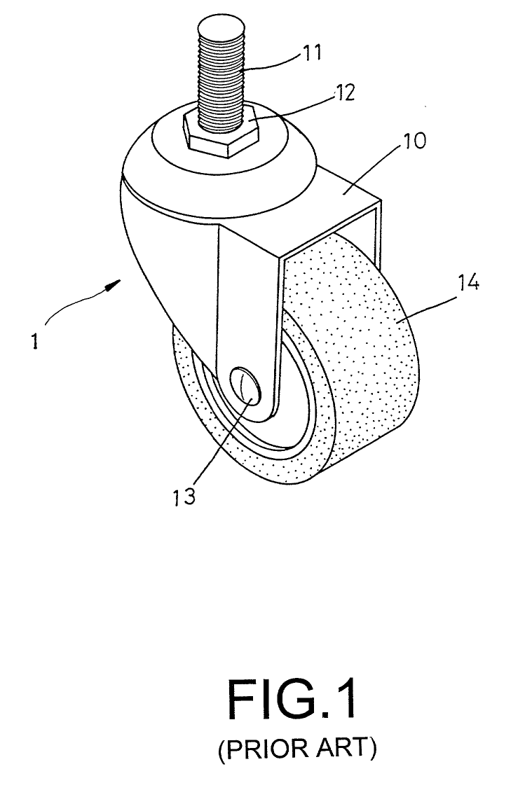

FIG. 2 is an exploded perspective view of a chair caster with an immovable function in the present invention;

FIG. 3 is a perspective view of the chair caster with an immovable function in the present invention;

FIG. 4 is a sectional view of the chair caster with an immovable function in the present invention, showing the chair caster being fastened to a chair foot and not in a used status;

FIG. 5 is a sectional view of the chair caster with an immovable function in the present invention, showing the chair caster being fastened to the chair foot and in a used status; and,

FIG. 6 is a perspective view of the chair caster with an immovable function in the present invention, showing the chair caster being fastened to the chair foot and in the used status.

### DETAILED DESCRIPTION OF THE PREFERRED EMBODIMENT

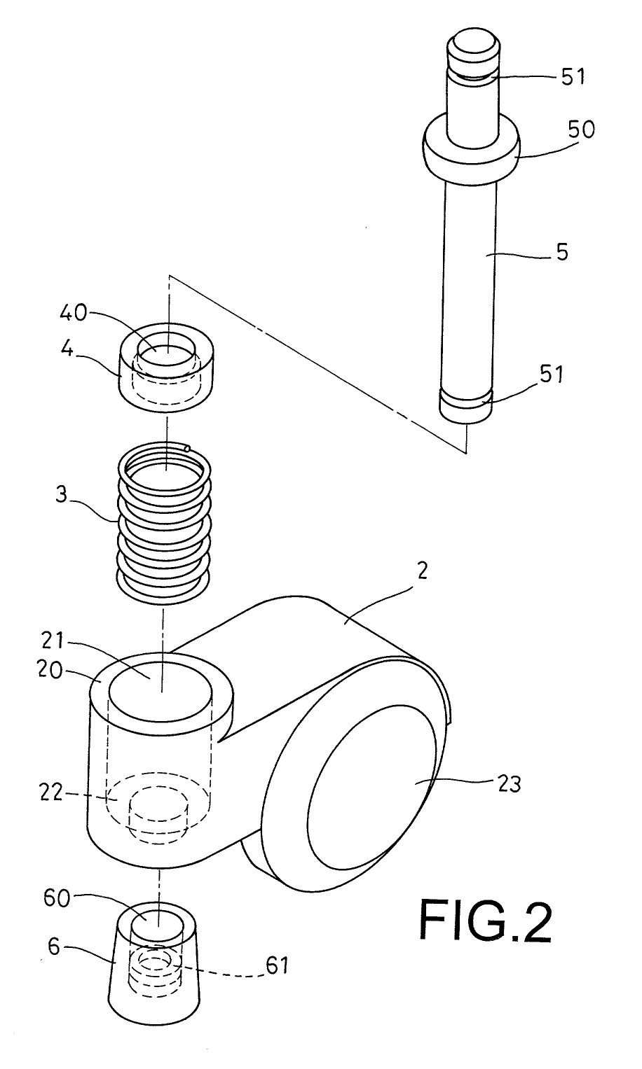

A preferred embodiment of a chair caster with an immovable function in the present invention, as shown in FIG. 2, mainly includes a wheel holder 2, a spring 3, a sleeve 4, a spindle 5, and a non-slip pad 6.

The wheel holder 2 has a spindle housing 20 disposed at an upper portion thereof and two wheel bodies 23 pivoted at a lower portion thereof. The spindle housing 20 has a spindle hole 21 being formed in a center thereof and extending through the center. The spindle hole 21 has a stop end 22 disposed at a lower portion of an inner wall therein.

The spring 3 is capable of being placed in the spindle hole 21 of the wheel holder 2 with one end of the spring 3 rested against the stop end 22 of the wheel holder 2.

The sleeve 4 is capable of being placed in the spindle hole 21 of the wheel holder 2 with a bottom of the sleeve 4 pressed against the other end of the spring 3. The sleeve 4 has a through hole 40 disposed in a center thereof.

The spindle 5 capable of extending from an upper end of the spindle hole 21 of the wheel holder 2, passing through the through hole 40 of the sleeve 4 and the spring 3, and protruding out of a lower end of the spindle hole 21 of the wheel holder 2. The spindle 5 has two ring grooves 51, 51 respectively disposed at an upper portion and a lower portion thereof, and an annular flange 50 disposed proximate the upper portion.

The non-slip pad 6 capable of being engaged with the ring groove 51 at the lower portion of the spindle 5 has a recess 60 disposed at a center thereof. The recess 60 has a circumferential ridge 61 disposed in an inner wall therein.

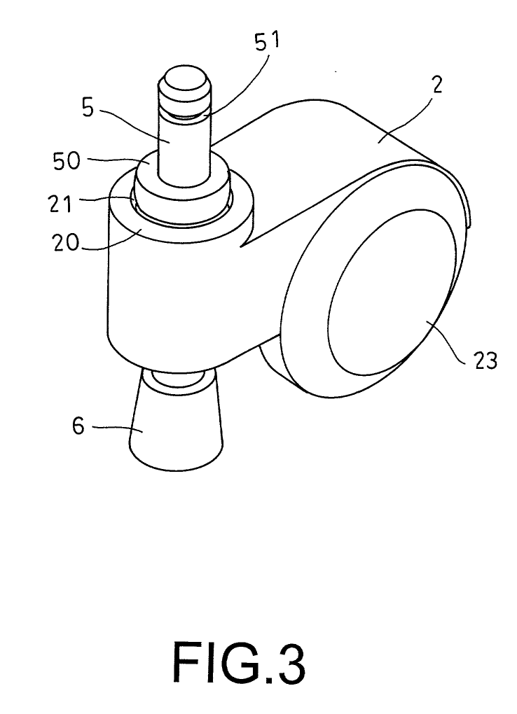

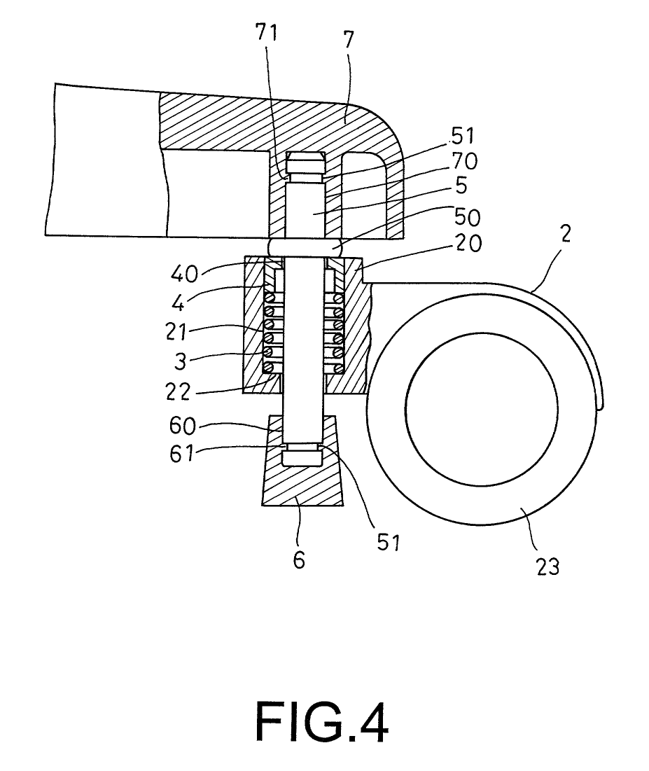

In assembling, referring to FIGS. 2, 3 and 4, firstly place the spring 3 into the spindle hole 21 of the wheel holder 2 with one end of the spring 3 rested against the stop end 22 of the wheel holder 2. Secondly, place the sleeve 4 into the spindle hole 21 of the wheel holder 2 with the bottom of the sleeve 4 pressed against the other end of the spring 3. Thirdly, extend the spindle 5 from the upper end of the spindle hole 21 of the wheel holder 2, through the through hole 40 of the sleeve 4 and the spring 3, and out of the lower end of the spindle hole 21 of the wheel holder 2. Finally, correspond the recess 60 of the non-slip pad 6 to a bottom of the spindle 5 to make the ring groove 51 at the lower portion of the spindle 5 engaged by the circumferential ridge 61 of the non-slip pad 6, by which the chair caster of the present invention is assembled all together, as shown in FIG. 3, and the assembled chair caster is capable of being fastened to a chair foot 7 to be ready for using by having the ring groove 51 at the upper portion of the spindle 5 engaged by the circumferential ridge 71 in a recess 70 of the chair foot 7, as shown in FIG. 4.

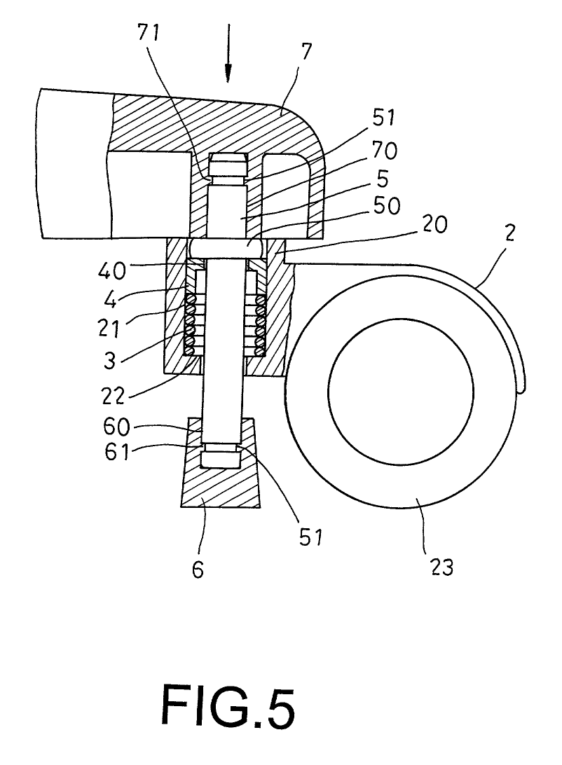

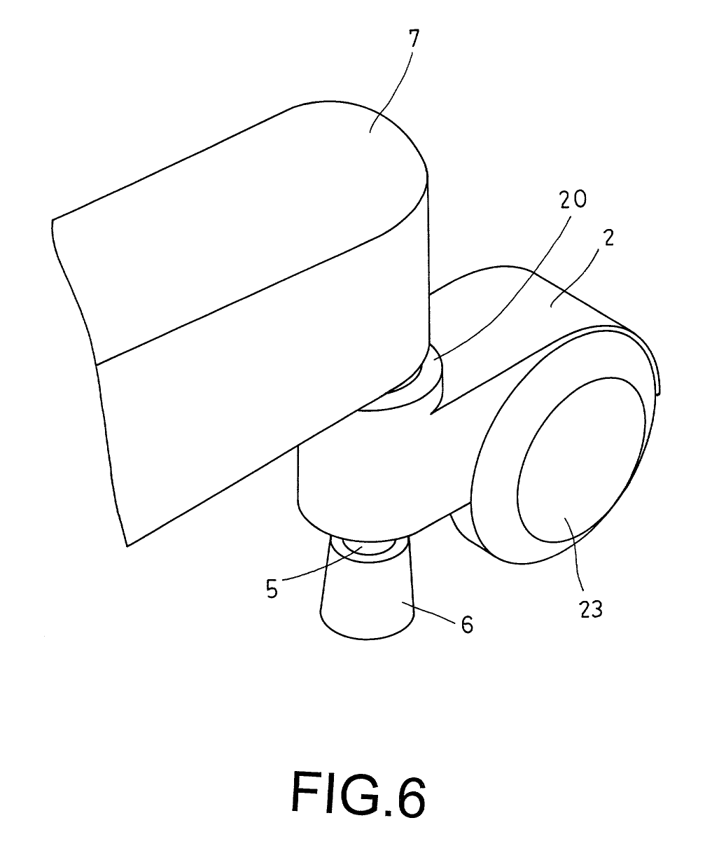

In using, referring to FIGS. 4, 5 and 6, when a user sits on the chair, the weight of the user forces the chair foot 7 to make the spindle 5 moved downwards with the annular flange 50 of the spindle 5 pressed against a top of the sleeve 4 to lower the sleeve 4 to compress the spring 3 with both ends of the spring 3 respectively pressed against the bottom of the sleeve 4 and the stop end 22 of the wheel holder 2 so that the non-slip pad 6 engaged at the lower portion of the spindle 5 follows downward movement of the spindle 5 to be affixed to the ground, as shown in FIG. 5, thereby enabling the chair to remain immovable in a certain location. When the user leaves the chair, the bottom of the sleeve 4 will be immediately urged under the resilience of the spring 3 to make the sleeve 4 moved upwards so that the annular flange 50 of the spindle 5 are pushed by the sleeve 4 to make the spindle 5 moved upwards. In the meantime, the non-slip pad 6 engaged at the lower portion of the spindle 5 follows upward movement of the spindle 5 not to be contacted with the ground, as shown in FIG. 4, thereby enabling the chair to move at any time without limitation.

In such a way, when the user sits on the chair, the chair caster of the present invention can limit the chair to remain immovable in a certain location without worry of displacing the chair to make the user suffered a fall and thus wounded; when the user leaves the chair, the chair caster allows the chair to move at any time without limitation.

While the preferred embodiment of the invention has been described above, it will be recognized and understood that various modifications may be made therein and the appended claims are intended to cover all such modifications that may fall within the spirit and scope of the invention.

What is claimed is:

1. A chair caster with an immovable function comprising:
a wheel holder having a spindle housing disposed at an upper portion thereof and two wheel bodies pivoted at a lower portion thereof, said spindle housing provided with a spindle hole formed in a center thereof, said spindle hole provided with a stop end disposed therein;
a spring capable of being placed in said spindle hole of said wheel holder;
a sleeve capable of being placed in said spindle hole of said wheel holder and having a through hole disposed in a center thereof;
a spindle capable of extending from an upper end of said spindle hole of said wheel holder, passing through said through hole of said sleeve and said spring, and protruding out of a lower end of said spindle hole of said wheel holder, said spindle having two ring grooves respectively disposed at an upper portion and a lower portion thereof, and an annular flange disposed proximate said upper portion; and,
a non-slip pad capable of being engaged with said ring groove at said lower portion of said spindle and having a recess disposed at a center thereof, said recess provided with a circumferential ridge disposed therein; and,
whereby with a combination of aforesaid components, when a user sits on a chair, said spindle is capable of being lowered by the weight of a user with said annular flange of said spindle pressed against said sleeve to lower said sleeve to compress said spring with both ends of said spring respectively pressed against a bottom of said sleeve and said stop end of said wheel holder so that said non-slip pad engaged at said lower portion of said spindle follows downward movement of said spindle to be affixed to the ground, thereby enabling said chair to remain immovable in a certain location without worry of displacing said chair to make said user suffered a fall and thus wounded.
